(19) United States
(12) Patent Application Publication
(10) Pub. No.: US 2025/0358824 A1
(43) Pub. Date: Nov. 20, 2025

(54) BASE STATION, WIRELESS COMMUNICATION METHOD, WIRELESS COMMUNICATION SYSTEM, AND COMPUTER-READABLE MEDIUM

(71) Applicant: NEC Corporation, Minato-ku, Tokyo (JP)

(72) Inventor: Motoya IWASAKI, Tokyo (JP)

(73) Assignee: NEC Corporation, Minato-ku, Tokyo (JP)

(21) Appl. No.: 18/864,594

(22) PCT Filed: Jun. 23, 2023
(86) PCT No.: PCT/JP2023/023308

§ 371 Date: Nov. 11, 2024

(30) Foreign Application Priority Data
Jul. 6, 2022 (JP) 2022-109081

(51) Int. Cl. H04W 72/23; H04L 27/26

(52) U.S. Cl. CPC H04W 72/23; H04L 27/26

(57) ABSTRACT

Provided is a base station (10) including: a control unit (12) for performing processing for wireless transmission after a reference signal is phase-rotated and then multiplexed on a frequency axis in a first symbol of a downlink signal included in two symbols to be transmitted, and performing the processing for wireless transmission after the reference signal is multiplexed in a second symbol on the frequency axis; and a transmission unit (11) for wirelessly transmitting a downlink signal generated by the control unit.

### TECHNICAL FIELD

The present disclosure relates to a base station, a wireless communication method, a wireless communication system, and a program.

### BACKGROUND ART

In mobile communications, with the fifth-generation (5G), a time division duplex (TDD) system in which a downlink (DL) signal and an uplink (UL) signal are multiplexed in a time division manner has become mainstream.

In the TDD system, the same frequency is used in the DL and the UL, so that it is necessary to strictly separate the time zones of the DL and the UL. However, due to the situation of a radio wave propagation environment, the DL signal of the base station may reach an extremely distant base station at a high level. In this case, since a distance between base stations is large, a propagation delay becomes considerably large, and the DL signal may be received at the distant base station in the UL time zone. Thus, this signal becomes a factor of interference with a UL signal from a terminal in the distant base station.

In order to avoid this, the distant base station takes measures such as not allocating the transmission of the UL signal to the terminal at the time when the interference is received, but to implement the measures, it is necessary to grasp that the interference is received. For this purpose, in third generation partnership project (3GPP) (registered trademark) standardization, a method is specified in which a base station multiplexes a reference signal, which is called remote interference management reference signal (RIM-RS), for identifying interference in a DL signal and transmits the result (see, for example, Patent Literature 1).

### CITATION LIST

### Patent Literature

Patent Literature 1: Published Japanese Translation of PCT International Publication for Patent Application, No. 2022-501937

### SUMMARY OF INVENTION

However, in the related technology, for example, there is a problem that it is difficult to appropriately generate a reference signal such as a RIM-RS. In view of the above-described problems, an object of the present disclosure is to provide a base station, a wireless communication method, a wireless communication system, and a program capable of appropriately generating a reference signal for wireless communication.

In a first aspect of the present disclosure, there is provided a base station including: a control unit for performing processing for wireless transmission after a reference signal is phase-rotated and then multiplexed on a frequency axis in a first symbol of a downlink signal included in two symbols to be transmitted, and performing the processing for wireless transmission after the reference signal is multiplexed in a second symbol on the frequency axis; and a transmission unit for wirelessly transmitting a downlink signal generated by the control unit.

In addition, in a second aspect according to the present disclosure, there is provided a wireless communication method including: performing, by a base station, processing for wireless transmission after a reference signal is phase-rotated and then multiplexed on a frequency axis in a first symbol of a downlink signal included in two symbols to be transmitted: performing, by a base station, the processing for wireless transmission after the reference signal is multiplexed in a second symbol on the frequency axis; and wirelessly transmitting a downlink signal of two symbols generated by the processing for wireless transmission.

In addition, in a third aspect of the present disclosure, there is provided a wireless communication system including: a base station; and a terminal. The base station includes a control unit for performing processing for wireless transmission after a reference signal is phase-rotated and then multiplexed on a frequency axis in a first symbol of a downlink signal included in two symbols to be transmitted, and performing the processing for wireless transmission after the reference signal is multiplexed in a second symbol on the frequency axis, and a transmission unit for wirelessly transmitting a downlink signal generated by the control unit.

In addition, in a fourth aspect according to the present disclosure, there is provided a program for causing a computer to execute: processing for wireless transmission after a reference signal is phase-rotated and then multiplexed on a frequency axis in a first symbol of a downlink signal included in two symbols to be transmitted: the processing for wireless transmission after the reference signal is multiplexed in a second symbol on the frequency axis; and wirelessly transmitting a downlink signal of two symbols generated by the processing for wireless transmission.

### BRIEF DESCRIPTION OF DRAWINGS

FIG. 1 is a diagram illustrating a configuration example of a wireless communication system according to an example embodiment.

FIG. 2 is a diagram illustrating an example of a configuration of a base station according to the example embodiment.

FIG. 3 is a flowchart illustrating an example of processing of the base station according to the example embodiment.

FIG. 4 is a diagram illustrating an example of processing for a first symbol of a DL signal according to the example embodiment.

FIG. 5 is a diagram illustrating an example of processing for a second symbol of the DL signal according to the example embodiment.

FIG. 6 is a diagram illustrating comparison between a normal DL signal and a RIM-RS according to the example embodiment when viewed on a time axis.

FIG. 7 is a diagram illustrating an example of a RIM-RS signal for wireless transmission according to the example embodiment.

FIG. 8 is a diagram illustrating an example of processing for the normal DL signal according to the example embodiment.

FIG. 9 is a diagram illustrating a comparative example of processing on the RIM-RS signal.

FIG. 10 is a diagram illustrating an example of DL mapping according to the example embodiment.

FIG. 11 is a diagram illustrating a comparative example of processing on the normal DL signal and the RIM-RS signal for wireless transmission.

FIG. 12 is a diagram illustrating an example of configurations of a base station and a terminal according to the example embodiment.

### EXAMPLE EMBODIMENT

The principles of the present disclosure will be described with reference to several example embodiments. It is to be understood that the example embodiments have been described for purposes of illustration only and will aid those skilled in the art in understanding and carrying out the present disclosure without suggesting limitations on the scope of the present disclosure. The disclosure described in the present specification is implemented in various methods other than those described below.

In the following description and claims, unless defined otherwise, all technical and scientific terms used in the present specification have the same meaning as commonly understood by those skilled in the art of the technical field to which the present disclosure belongs.

Hereinafter, example embodiments of the present invention will be described with reference to the drawings.

### System Configuration

FIG. 1 is a diagram illustrating a configuration example of a wireless communication system 1 according to an example embodiment. In FIG. 1, a wireless communication system 1 includes a base station 10 and a terminal 20. A range (coverage) in which the terminal 20 can receive a radio wave from the base station 10 is also referred to as a cell 30. Note that the numbers of the base stations 10 and the terminals 20 are not limited to the example of FIG. 1.

The base station 10 and the terminal 20 are connected so as to be able to communicate by wireless communication such as a fifth-generation mobile communication system (5G), a sixth-generation mobile communication system (6G, Beyond 5G), a fourth-generation mobile communication system (4G), or a wireless local area network (LAN).

It should be noted that, the term “base station” (BS) used in the present disclosure refers to a device that can provide or host a cell or coverage in which the terminal 20 can communicate. Examples of the base station 10 include, but are not limited to, a Node B (or NB), an evolved Node B (eNode B or eNB), a next-generation Node B (gNB), a remote radio unit (RRU), a radio head (RH), a remote radio head (RRH), a low power node (for example, femto node, pico node), and the like.

The term “terminal” used in the present disclosure refers to any device having a wireless or wired communication function. Examples of the terminal 20 include, but are not limited to, a user equipment (UE), a personal computer, a desktop, a mobile phone, a cellular phone, a smartphone, a personal digital assistant (PDA), a portable computer, an image capture device such as a digital camera, a gaming device, a music storage and playback device, or Internet equipment that enables wireless Internet access, browsing, and the like.

The communications described in the present disclosure may conform to any suitable standard including, but not limited to, 5G (NR: New Radio), 6G, 4G (LTE-Advanced, WiMAX2), Long Term Evolution (LTE), wideband code division multiple access (W-CDMA), code division multiple access (CDMA), Global System for Mobile Communications (GSM: Global System for Mobile), and the like. Further, communication may be executed in accordance with any generation of communication protocols now known or developed in the future.

In addition to normal data communication, the base station 10 may transmit a downlink reference signal (RS) to the terminal 20 in broadcast, multicast, and unicast manners. Similarly, the terminal 20 may transmit the RS to the base station 10 on the uplink. As used herein, “downlink” refers to a link from the base station 10 to the terminal 20, and “uplink” refers to a link from the terminal 20 to the base station 10. The following description describes the example embodiment related to downlink RS transmission.

For example, the RS of downlink is used by the terminal 20, for example, for beam sweeping, channel estimation, demodulation, other operations for communication, and the like. In general, the RS is a signal sequence (also referred to as an “RS sequence”) known by both the base station 10 and the terminal 20. For example, the RS sequence is generated and transmitted by the base station 10 on the basis of a certain rule, and the terminal 20 estimates the RS sequence on the basis of the same rule. In the following description, the RS is described with reference to a RIM-RS. Note that the technology of the present disclosure is not limited to the RIM-RS, and can be applied to various reference signals having the same specification as the RIM-RS described below.

### Configuration

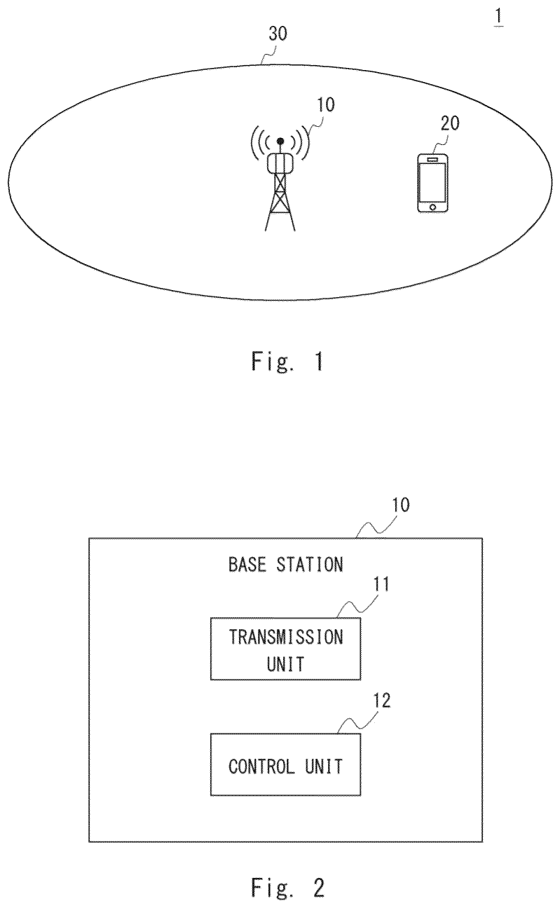

A configuration of the base station 10 according to the example embodiment will be described with reference to FIG. 2. FIG. 2 is a diagram illustrating an example of a configuration of the base station 10 according to the example embodiment. Note that the configuration illustrated in FIG. 2 is merely an example. The name of each unit may be any name as long as the processing of the present disclosure can be executed.

### <<Base Station 10>>

The base station 10 includes a transmission unit 11 and a control unit 12. The transmission unit 11 wirelessly transmits the signal generated by the control unit 12 to the terminal 20.

The control unit 12 performs processing for wireless transmission after phase-rotating a reference signal and then multiplexing the reference signal on a frequency axis in a first symbol of a downlink signal included in two symbols to be transmitted. In addition, the control unit 12 performs the processing for wireless transmission after multiplexing the reference signal on the frequency axis in a second symbol of the downlink signal of two symbols to be transmitted.

### Processing

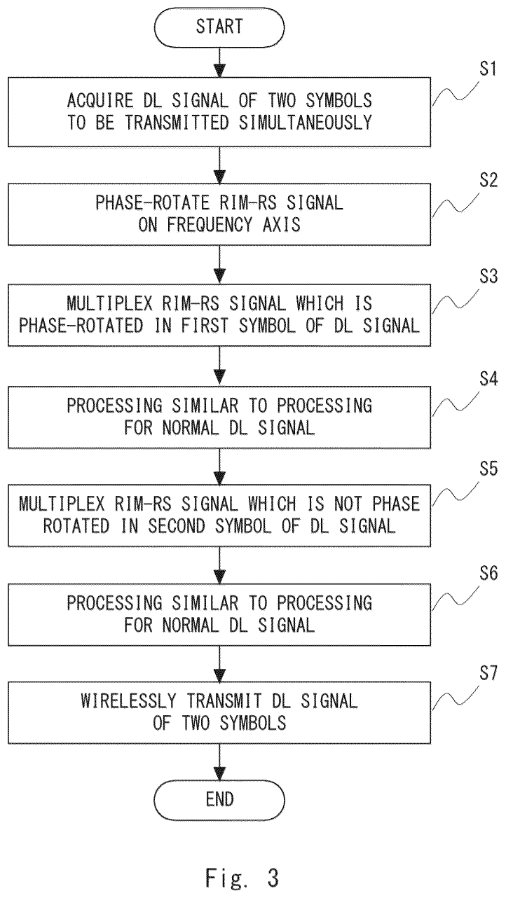

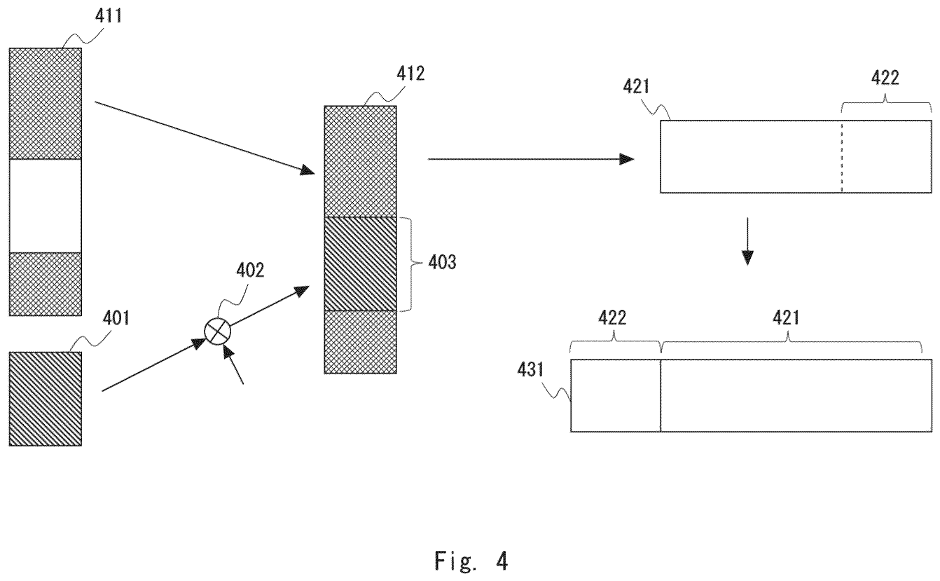

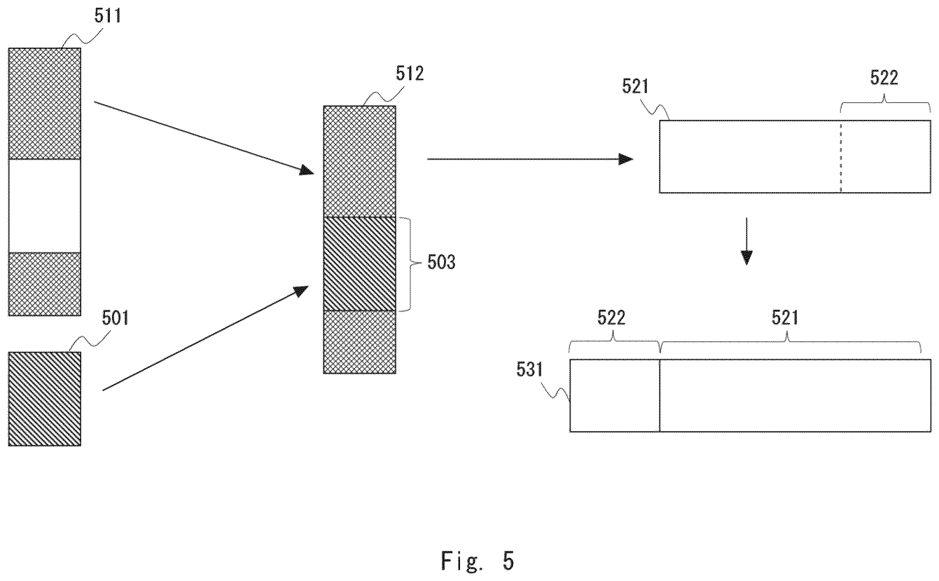

Next, an example of processing of the base station 10 according to the example embodiment will be described with reference to FIGS. 3 to 5. FIG. 3 is a flowchart illustrating an example of processing of the base station 10 according to the example embodiment. FIG. 4 is a diagram illustrating an example of processing for the first symbol of a DL signal according to the example embodiment. FIG. 5 is a diagram illustrating an example of processing for the second symbol of the DL signal according to the example embodiment.

In step S1, the control unit 12 acquires a DL signal included in two symbols to be transmitted simultaneously.

Subsequently, the control unit 12 phase-rotates an original RIM-RS signal on the frequency axis according to the length of the cyclic prefix (CP) of the RIM-RS signal for wireless transmission (the CP length with respect to the DL signal of two symbols) (step S2). Here, as illustrated in FIG. 4, a RIM-RS signal 401 is phase-rotated at a point 402.

Subsequently, the control unit 12 multiplexes the RIM-RS signal which is phase-rotated in the first symbol of the DL signal on the frequency axis (step S3). Here, as illustrated in FIG. 4, a signal 412 is generated in which the phase-rotated RIM-RS signal 403 is multiplexed in the first symbol 411 of the DL signal on the frequency axis.

Subsequently, the control unit 12 performs processing similar to the processing for the normal DL signal on the signal generated in the processing of step S3 (step S4). Here, for example, the control unit 12 may convert the signal generated in the processing of step S3 into a time-axis signal by inverse fast Fourier transform (IFFT), and then add CP.

By modifying the RIM-RS signal on the frequency axis, the subsequent processing (for example, IFFT and CP addition) can be made identical to the processing for the normal DL signal. Therefore, for example, a circuit or the like that performs subsequent processing can be made common, so that an increase in the scale of the circuit or the like can be avoided.

Here, as illustrated in FIG. 4, the signal 412 may be converted into a time-axis signal (IFFT signal) 421 by IFFT, and CP, which is data obtained by copying a part 422 of the signal at the rear end of the IFFT signal 421, may be added to the head of the IFFT signal 421, thereby generating one symbol 431.

Subsequently, the control unit 12 multiplexes the original RIM-RS signal which is not phase-rotated as it is (without performing phase rotation) in the second symbol of the DL signal on the frequency axis (step S5). Here, as illustrated in FIG. 5, a signal 512 is generated in which the RIM-RS signal 501 which is not phase-rotated is multiplexed in the first symbol 511 of the DL signal on the frequency axis.

Subsequently, the control unit 12 performs processing similar to the processing for the normal DL signal on the signal generated in the processing of step S5 (step S6). Here, for example, the control unit 12 may convert the signal generated in the processing of step S5 into a time-axis signal by IFFT, and then add CP.

Here, as illustrated in FIG. 5, the signal 512 may be converted into an IFFT signal 521, and CP, which is data obtained by copying a part 522 of the signal at the rear end of the IFFT signal 521 may be added to the head of the IFFT signal 521, thereby generating one symbol 531.

Subsequently, the transmission unit 11 wirelessly transmits the DL signal of two symbols processed by the control unit 12 (step S7). Note that the normal DL signal and the RIM-RS signal according to the example embodiment are signals conforming to 3GPP specifications (regulations).

Note that for the normal DL signal of NR, the control unit 12 may generate a signal (IFFT signal) obtained by converting a signal on the frequency axis into a time-axis signal by IFFT. Note that the normal DL signal of NR may include, for example, at least one of a physical downlink shared channel (PDSCH) and a physical downlink control channel (PDCCH).

Then, the control unit 12 may add CP, which is obtained by copying a part of the signal at the rear end of the generated IFFT signal, to the head of the original IFFT signal, thereby generating one symbol. Here, the head and the tail of the IFFT signal are continuous signals due to the nature of IFFT, so that the added CP is a signal continuous with the head of the IFFT signal.

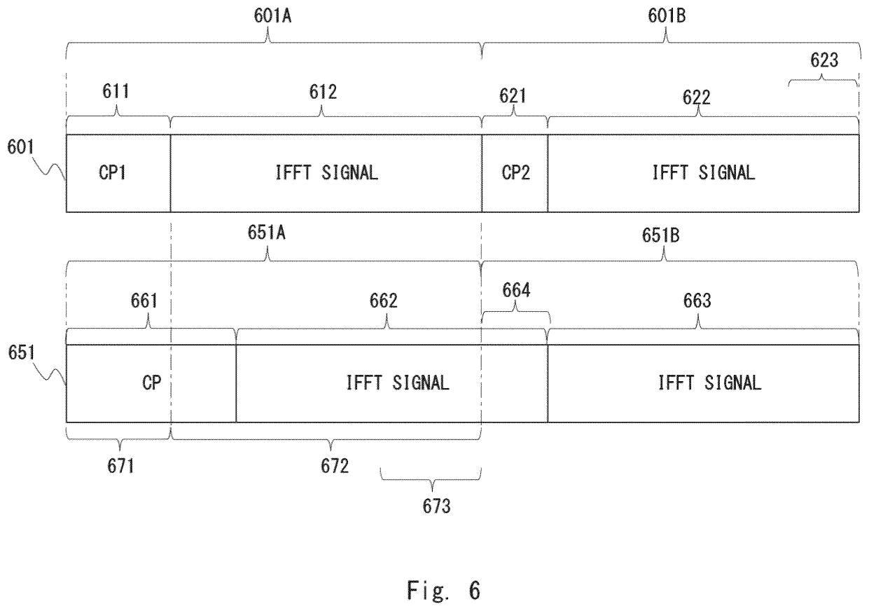

FIG. 6 is a diagram illustrating comparison between the normal DL signal and the RIM-RS signal according to the example embodiment when viewed on a time axis. First, a portion of the second symbol in the normal DL signal and the RIM-RS signal will be described. In a normal DL signal 601, a rear end portion 623 of an IFFT signal 622 of a second symbol 601B is copied and added as CP (CP2) to a head portion 621 of the second symbol.

On the other hand, in a RIM-RS signal 651, an IFFT signal 663 is similar to that of the normal DL signal, and the head portion of a second symbol 651B includes a rear end portion 664 of a previous IFFT signal 662. The IFFT signal 662 and the IFFT signal 663 included in the RIM-RS signal 651 are the same signal. Therefore, the rear end portion 664 of the IFFT signal 662 in the RIM-RS signal 651 can be generated by the same processing as the signal added as CP2 in the case of the normal DL signal.

Therefore, it can be seen that, for the second symbol 651B of the RIM-RS signal 651 for wireless transmission, if the original RIM-RS signal is multiplexed in the DL signal on the frequency axis as it is (without phase rotation), a desired RIM-RS signal (for wireless transmission) can be obtained by the subsequent processing applied to the normal DL signal.

Next, the first symbol will be described. In the RIM-RS signal 651, compared to the normal DL signal 601, the IFFT signal 662 is shifted back in time by the length of the portion 621 of CP2, and a portion 661 of CP is also shifted back by the same length. In addition, the IFFT signal 662 and the IFFT signal 663 included in the RIM-RS signal 651 are the same signal.

Therefore, a portion 672 of the RIM-RS signal at the time of an IFFT signal 612 of a first symbol 601A of the normal DL signal 601 can be regarded as a signal obtained by cyclically shifting the IFFT signal 662 back by the length of the CP2. This is because the portion 672 of the RIM-RS signal can be regarded as a signal obtained by cutting off the rear end portion 664 of the IFFT signal 662 and adding the portion to the head of the IFFT signal 662.

In addition, a portion 671 of the RIM-RS signal at the time of the portion 611 of the CP1 of the normal DL signal 601 is a signal generated by performing processing, which is similar to the processing of generating the portion 611 of the CP1 of the normal DL signal 601, on the cyclically-shifted IFFT signal 662. This is because the portion 671 of the RIM-RS signal can be regarded as a rear end portion 673 of the signal 672, in which the IFFT signal 662 is cyclically shifted, added to the head of the signal 672.

Therefore, it can be seen that, for the first symbol 651A of the RIM-RS signal 651 for wireless transmission, if the signal obtained by cyclically shifting the original RIM-RS signal by the length of the CP2 is multiplexed in the DL signal on the frequency axis, a desired RIM-RS signal (for wireless transmission) can be obtained by the subsequent processing applied to the normal DL signal.

That is, for the first symbol and the second symbol, in the subsequent processing after the processing in which the original RIM-RS signal is multiplexed in the DL signal on the frequency axis before performing IFFT, the processing such as IFFT and CP addition can be shared between the RIM-RS signal for wireless transmission and the normal DL signal.

In this regard, in step S2 of FIG. 3, the control unit 12 performs processing, which is equivalent to cyclic shift on the time axis after IFFT, on the original RIM-RS signal on the frequency axis. More specifically, the control unit 12 phase-rotates the original RIM-RS signal. This is because the time shift on the time axis corresponds to rotation of the phase on the frequency axis.

In this case, the control unit 12 may generate a phase-rotated signal F′(k) by adding phase rotation to an original RIM-RS signal F (k) as in following Formula (1). Herein, k is a frequency (the position of the RIM-RS on the frequency axis) and k₀ is the starting position of the RIM-RS on the frequency axis. In addition, N_{CP} represents the length of CP (the length of CP of the RIM-RS signal for wireless transmission, the length of CP with respect to the downlink signal of two symbols), and Nu represents the number of FFT points when IFFT is performed.

$$\begin{matrix}[ Equation 1 ] & \\ {F}^{′} ( k ) = F ( k ) {e}^{j 2 π \frac{{N}_{CP}}{{N}_{u}} ( k + {k}_{0} )} & ( 1 )\end{matrix}$$

A signal f′(n) on the time axis obtained by performing IFFT on a phase-rotated signal F′(k) is expressed by following Formula (2). Herein, K is the number of subcarriers on the frequency axis of the RIM-RS.

$$\begin{matrix}[ Equation 2 ] & \\ {f}^{′} ( n ) = {\sum }_{k = 0}^{K - 1} {F}^{′} ( k ) {e}^{j 2 π \frac{n}{{N}_{u}} ( k + {k}_{0} )} = {\sum }_{k = 0}^{K - 1} [ F ( k ) {e}^{- j 2 π \frac{{N}_{CP}}{{N}_{u}} ( k + {k}_{0} )} ] {e}^{j 2 π \frac{n}{{N}_{u}} ( k + {k}_{0} )} = {\sum }_{k = 0}^{K - 1} F ( k ) {e}^{j 2 π \frac{n - {N}_{CP}}{{N}_{u}} ( k + {k}_{0} )} & ( 2 )\end{matrix}$$

On the other hand, a signal f(n) on the time axis obtained by performing IFFT on a signal before the phase rotation is performed is expressed by following Formula (3).

$$\begin{matrix}[ Equation 3 ] & \\ f ( n ) = {\sum }_{k = 0}^{K - 1} F ( k ) {e}^{j 2 π \frac{n}{{N}_{u}} ( k + {k}_{0} )} & ( 3 )\end{matrix}$$

By comparing Formula (3) and Formula (2), it can be seen that f(n) is related to f(n) by following Formula (4).

$$\begin{matrix}[ Equation 4 ] & \\ {f}^{′} ( n ) = f ( n - {N}_{CP} ) & ( 4 )\end{matrix}$$

This indicates that F′(k) becomes a signal obtained when f(n) is shifted in time by N_{CP} after IFFT, and thus it can be seen that a desired signal is obtained by the processing described in FIG. 3.

### Others

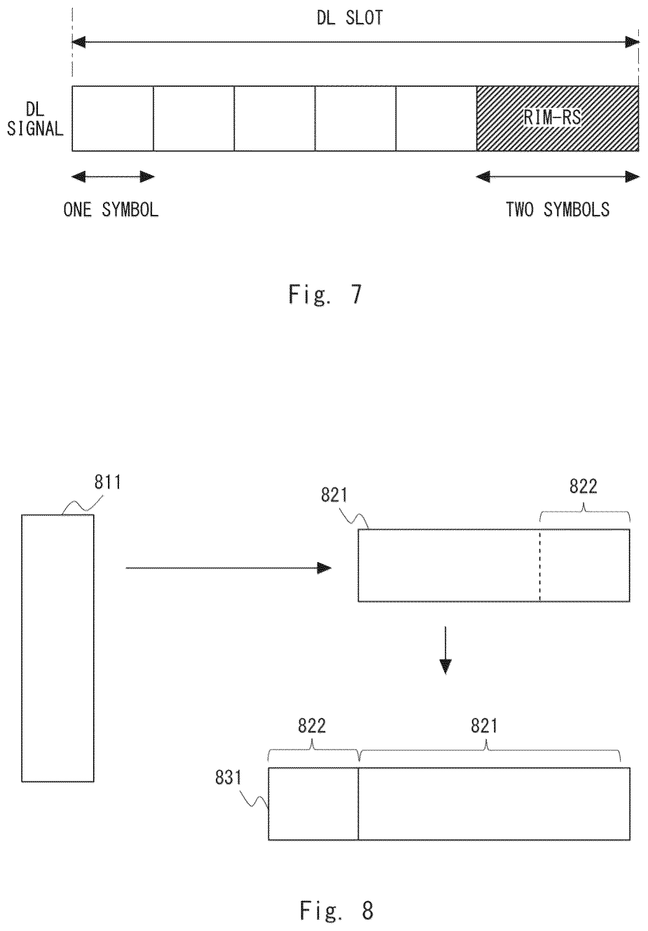

FIG. 7 is a diagram illustrating an example of the RIM-RS signal for wireless transmission according to the example embodiment. In the example of FIG. 7, a RIM-RS signal having a length equivalent to two symbols is transmitted at the end of a DL slot including a plurality of symbols in accordance with the 3GPP specification (definition).

FIG. 8 is a diagram illustrating an example of processing for the normal DL signal according to the example embodiment. As described above, in the case of the normal DL signal (for example, PDSCH, PDCCH) of NR, a signal 811 on the frequency axis is converted into a signal 821 on the time axis by IFFT, a rear end portion 822 of the signal 821 is copied and added as CP to the head of the original signal 821, thereby generating one symbol 831.

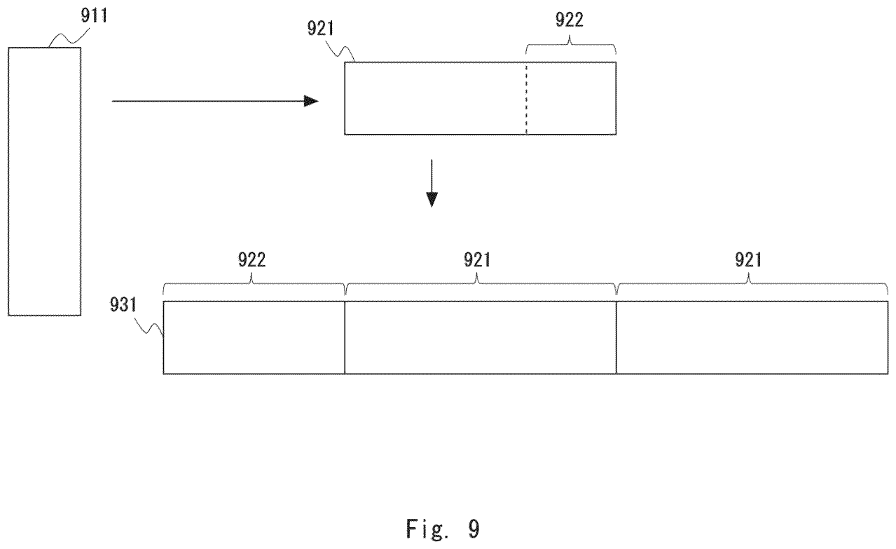

FIG. 9 is a diagram illustrating a comparative example of processing on the RIM-RS signal. In the case of the RIM-RS signal for wireless transmission, first, a signal 911 on the frequency axis is converted into a signal 921 on the time axis by IFFT. Then, a rear end portion 922 of the signal 921 is copied and added as CP to the head of the original signal 921. Here, the rear end portion 922 is a signal having a length equivalent to the total CP length for two symbols. Further, the signal 921 is added to the rear of original signal 921, thereby generating a 2-symbol RIM-RS signal 931 for wireless transmission conforming to the 3GPP specification.

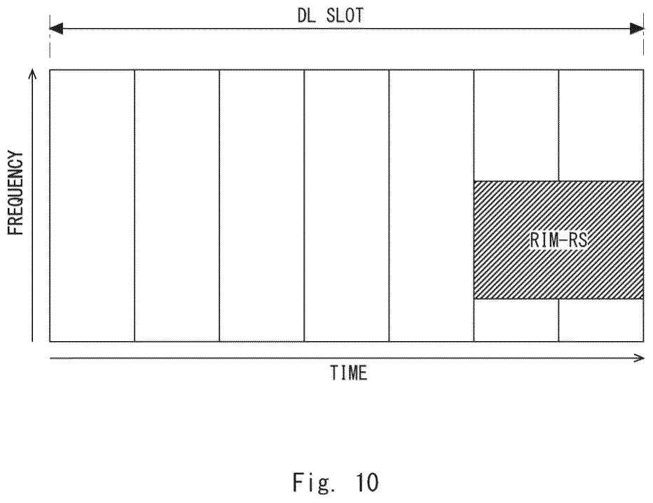

FIG. 10 is a diagram illustrating an example of DL mapping according to the example embodiment. As illustrated in FIG. 10, the RIM-RS signal for wireless transmission is frequency-multiplexed in a normal DL signal. In this case, the DL signal is allocated up to the last symbol of the DL slot. Therefore, in the section of two symbols including the RIM-RS signal for wireless transmission, the normal DL signal and the RIM-RS signal for wireless transmission are mixed. Therefore, it is difficult to use one circuit or the like to switch between an operation (processing) for the normal DL signal and an operation for the RIM-RS signal for wireless transmission in a time division manner.

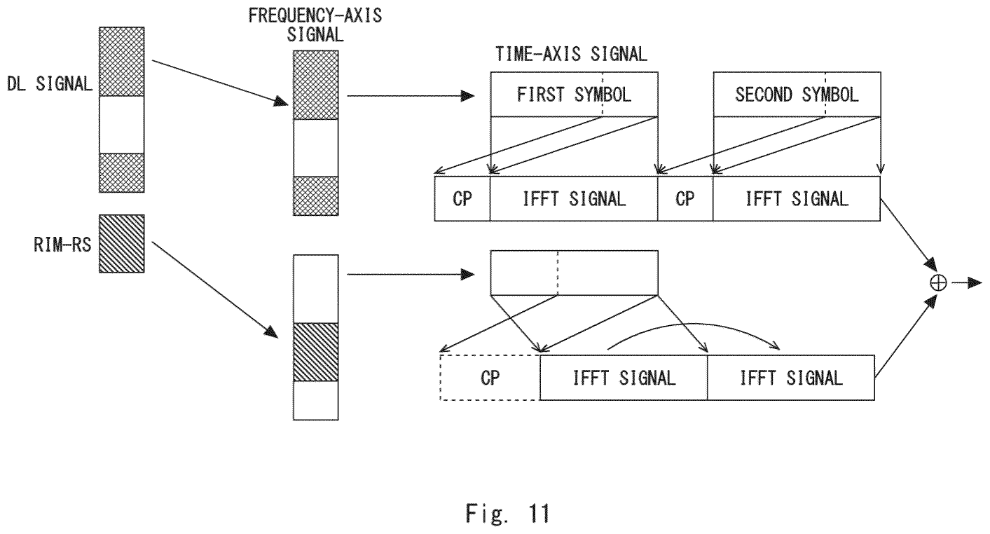

FIG. 11 is a diagram illustrating a comparative example of processing on the normal DL signal and the RIM-RS signal for wireless transmission. As illustrated in FIG. 11, in a case where a circuit that performs an operation for a normal DL signal and a circuit that performs an operation for a RIM-RS signal for wireless transmission are provided and implemented such that the outputs of respective circuits are multiplexed, a circuit for RIM-RS processing is added, which causes a problem of an increase in circuit scale.

On the other hand, according to the technology of the present disclosure, for example, the specification of the RIM-RS can be satisfied by a relatively small circuit or the like for performing the phase rotation on the frequency axis. Therefore, for example, the scale of the circuit or the like can be reduced.

### Modified Example

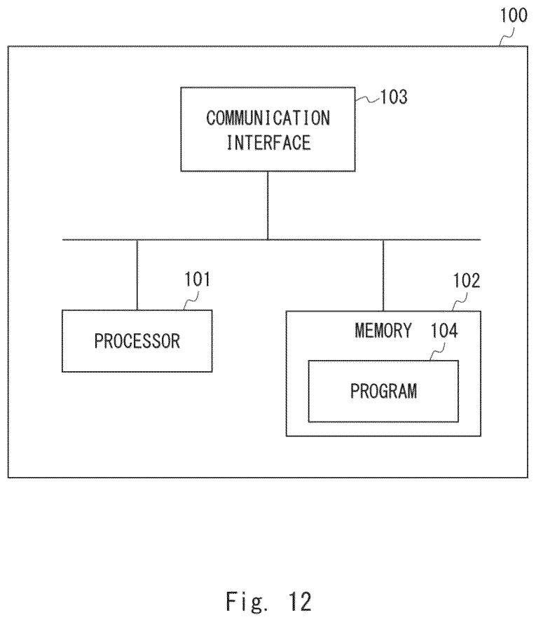

FIG. 12 is a diagram illustrating an example of a configuration of a computer 100 in a case where at least a part (for example, the control unit 12) of the base station 10 or at least a part of the terminal 20 is achieved by a computer and a program. In the example of FIG. 12, the computer 100 includes a processor 101, a memory 102, and a communication interface 103. These units may be connected by a bus or the like. The memory 102 stores at least a part of a program 104. The communication interface 103 includes an interface necessary for communication with other network elements. In the case of the base station 10, the communication interface 103 includes, for example, an interface for communication with the terminal 20 via one or more antennas, an interface for communication between base stations, an interface for communication with various servers on the core network side, and the like.

When the program 104 is executed by the processor 101, the memory 102, and the like in cooperation with each other, at least a part of the processing according to the example embodiment of the present disclosure is executed by the computer 100. The memory 102 may be of any type suitable for a local technology network, and may be implemented using any suitable data storage technology, such as a non-transitory computer-readable storage medium, a semiconductor-based memory device, a magnetic memory device and system, an optical memory device and system, a fixed memory, or a removable memory, as a non-limiting example. Although only one memory 102 is illustrated in the computer 100, there may be several physically different memory modules in the computer 100. The processor 101 may be of any type suitable for a local technology network, and may include one or more of a general purpose computer, a dedicated computer, a microprocessor, a digital signal processor (DSP), and a processor based on a multi-core processor architecture as a non-limiting example. The computer 100 may include a plurality of processors such as application specific integrated circuit chips that are temporally dependent on a clock that synchronizes the main processor.

The example embodiments of the present disclosure may be implemented in hardware or dedicated circuitry, software, logic, or any combination thereof. Some aspects may be implemented in hardware, while other aspects may be implemented in firmware or software that may be executed by a controller, a microprocessor or other computing devices.

The present disclosure also provides at least one computer program product tangibly stored on a non-transitory computer-readable storage medium. The computer program product includes computer-executable instructions, such as those included in a program module, and is executed on a device on a target real or virtual processor to perform the processes or methods of the present disclosure. The program module includes routines, programs, libraries, objects, classes, components, data structures, and the like that execute particular tasks or implement particular abstract data types. The functions of the program module may be combined or divided between the program modules as desired in various example embodiments. A machine-executable instruction of the program module can be executed in a local or distributed device. In the distributed device, the program modules can be located on both local and remote storage media.

Program codes for executing the methods of the present disclosure may be written in any combination of one or more programming languages. These program codes may be provided to a processor or controller of a general purpose computer, a dedicated computer, or another programmable data processing apparatus, such that when the program codes are executed by the processor or controller, the functions/operations in the flowcharts and/or the implementing block diagrams are performed. The program code is executed entirely on a machine, partially on the machine as a stand-alone software package, partially on the machine and partially on a remote machine, or entirely on the remote machine or server.

The program code described above may be embodied in a machine-readable medium, which may be any tangible medium that can contain or store programs for use by or in connection with an instruction execution system, an apparatus, or a device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above. More specific examples of the machine-readable storage medium include one or more wires, a portable computer diskette, a hard disk, a random access memory (RAM), a read only memory (ROM), an erasable programmable read only memory (EPROM or flash memory), an optical fiber, a portable compact disc read only memory (CD-ROM), an optical storage device, a magnetic storage device, or an electrical connection having an appropriate combination of the above.

Note that the present invention is not limited to the above example embodiments, and can be appropriately changed without departing from the gist.

Some or all of the above-described example embodiments may be described as in the following Supplementary Notes, but are not limited to the following Supplementary Notes.

### Supplementary Note 1

A base station including:
a control unit for
performing processing for wireless transmission after a reference signal is phase-rotated and then multiplexed on a frequency axis in a first symbol of a downlink signal included in two symbols to be transmitted, and performing the processing for wireless transmission after the reference signal is multiplexed in a second symbol on the frequency axis; and
a transmission unit for wirelessly transmitting a downlink signal generated by the control unit.

### Supplementary Note 2

The base station according to supplementary note 1, in which the reference signal is a remote interference management reference signal (RIM-RS) signal.

### Supplementary Note 3

The base station according to supplementary note 1 or 2, in which the processing for wireless transmission includes processing of converting a signal on the frequency axis into a signal on a time axis and adding a cyclic prefix (CP).

### Supplementary Note 4

The base station according to supplementary note 3, in which the processing for wireless transmission is the same as processing for at least one of a physical downlink shared channel (PDSCH) or a physical downlink control channel (PDCCH).

### Supplementary Note 5

The base station according to supplementary note 1 or 2, in which the control unit rotates a phase of the reference signal according to a length of a cyclic prefix (CP) with respect to the downlink signal of two symbols.

### Supplementary Note 6

A wireless communication method including:
performing, by a base station, processing for wireless transmission after a reference signal is phase-rotated and then multiplexed on a frequency axis in a first symbol of a downlink signal included in two symbols to be transmitted;
performing, by a base station, the processing for wireless transmission after the reference signal is multiplexed in a second symbol on the frequency axis; and
wirelessly transmitting a downlink signal of two symbols generated by the processing for wireless transmission.

### Supplementary Note 7

A wireless communication system including:
a base station; and a terminal,
in which the base station includes
a control unit for
performing processing for wireless transmission after a reference signal is phase-rotated and then multiplexed on a frequency axis in a first symbol of a downlink signal included in two symbols to be transmitted, and
performing the processing for wireless transmission after the reference signal is multiplexed in a second symbol on the frequency axis, and
a transmission unit for wirelessly transmitting a downlink signal generated by the control unit.

### Supplementary Note 8

A program for causing a computer to execute:
processing for wireless transmission after a reference signal is phase-rotated and then multiplexed on a frequency axis in a first symbol of a downlink signal included in two symbols to be transmitted:
the processing for wireless transmission after the reference signal is multiplexed in a second symbol on the frequency axis; and
wirelessly transmitting a downlink signal of two symbols generated by the processing for wireless transmission.

Although the invention of the present application has been described above with reference to the example embodiments, the invention of the present application is not limited to the above. Various modifications that can be understood by those skilled in the art can be made to the configuration and details of the invention of the present application within the scope of the invention.

This application claims priority based on Japanese Patent Application No. 2022-109081 filed on Jul. 6, 2022, the entire disclosure of which is incorporated herein.

### REFERENCE SIGNS LIST

1 WIRELESS COMMUNICATION SYSTEM
10 BASE STATION
11 TRANSMISSION UNIT
12 CONTROL UNIT
20 TERMINAL
30 CELL

What is claimed is:

1. A base station comprising:
at least one memory storing instructions, and
at least one processor configured to execute the instructions to;
perform processing for wireless transmission after a reference signal is phase-rotated and then multiplexed on a frequency axis in a first symbol of a downlink signal included in two symbols to be transmitted,
perform the processing for wireless transmission after the reference signal is multiplexed in a second symbol on the frequency axis; and
wirelessly transmit a downlink signal generated by the processing for wireless transmission.

2. The base station according to claim 1, wherein the reference signal is a remote interference management reference signal (RIM-RS) signal.

3. The base station according to claim 1, wherein the processing for wireless transmission includes processing of converting a signal on the frequency axis into a signal on a time axis and adding a cyclic prefix (CP).

4. The base station according to claim 3, wherein the processing for wireless transmission is the same as processing for at least one of a physical downlink shared channel (PDSCH) or a physical downlink control channel (PDCCH).

5. The base station according to claim 1, wherein the at least one processor is configured to rotate a phase of the reference signal according to a length of a cyclic prefix (CP) with respect to the downlink signal of two symbols.

6. A wireless communication method comprising:
performing, by a base station, processing for wireless transmission after a reference signal is phase-rotated and then multiplexed on a frequency axis in a first symbol of a downlink signal included in two symbols to be transmitted;
performing, by a base station, the processing for wireless transmission after the reference signal is multiplexed in a second symbol on the frequency axis; and
wirelessly transmitting a downlink signal of two symbols generated by the processing for wireless transmission.

7. A wireless communication system comprising:
a base station; and a terminal,
wherein the base station includes
at least one memory storing instructions, and
at least one processor configured to execute the instructions to;
perform processing for wireless transmission after a reference signal is phase-rotated and then multiplexed on a frequency axis in a first symbol of a downlink signal included in two symbols to be transmitted,
perform the processing for wireless transmission after the reference signal is multiplexed in a second symbol on the frequency axis, and
wirelessly transmit a downlink signal generated by the processing for wireless transmission.

8. (canceled)
